(19) United States
(12) Patent Application Publication
(10) Pub. No.: US 2011/0264703 A1
(43) Pub. Date: Oct. 27, 2011

(54) Importing Tree Structure

(75) Inventors: Neil LYDICK, Seattle, WA (US); Jagadeesh Kalki, Redmond, WA (US); Mark Sterin, Redmond, WA (US)

(73) Assignee: Microsoft Corporation, Redmond, WA (US)

(21) Appl. No.: 12/767,807

(22) Filed: Apr. 27, 2010

(51) Int. Cl. G06F 17/30

(52) U.S. Cl. 707/797; 707/E17.087

(57) ABSTRACT

A set of structured data may be stored using a format file and a data file. The format file may contain a hierarchical structure in the form of classes and relationships, while the data file may store the instances of the data in a serialized form. The format file may include projection types as well as repeating or nested types. The data file may contain instances of the structured data in the form of rows, with commas or other delimiters separating the data items. The structure of the data file may be created by traversing the format file to create a fully populated list of data items representing the structured data. An application may read the format file and data file to import complex data types and populate instances of those data types.

### BACKGROUND

Exporting and importing information to and from computer applications is often used to move information from one application to another, as well as archiving and restoring information for an application.

One common file format for exporting and importing files is a Comma Separated Values or CSV format. In such a format, data may be stored in a large table, with each row of the file being separated by carriage returns or other delimiters, and each column of the table being separated by commas.

### SUMMARY

A set of structured data may be stored using a format file and a data file. The format file may contain a hierarchical structure in the form of classes and relationships, while the data file may store the instances of the data in a serialized form. The format file may include projection types as well as repeating or nested types. The data file may contain instances of the structured data in the form of rows, with commas or other delimiters separating the data items. The structure of the data file may be created by traversing the format file to create a fully populated list of data items representing the structured data. An application may read the format file and data file to import complex data types and populate instances of those data types.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system that may export and import data using a format file and a data file.

FIG. 2 is a diagram illustration of an example embodiment showing a data structure in XML form.

FIG. 3 is a diagram illustration of an example embodiment showing the data structure from FIG. 2 in a diagram form.

FIG. 4 is a flowchart illustration of an embodiment showing a method for exporting data into a format file and a data file.

FIG. 5 is a flowchart illustration of an embodiment showing a method for importing data from a format file and a data file.

### DETAILED DESCRIPTION

Complex data types may be represented in a format file, and instances of those data types may be stored in an instance or data file. The format file may define the data types, including properties for classes, as well as relationships between different types. The relationships may be parent/child relationships or other relationships.

The format file may be used to define how instance data may be arranged in the data file. The logic and sequence for creating the data file may be used for creating a data structure for importing an existing data file.

The format file may be defined using XML or other declarative language. The format file may include descriptions of a class and the properties associated with the class. In some embodiments, relationships between types may be used to reference other class types. In some embodiments, a ‘projection’ may be used to represent the data, which may correspond with a view or query for a database.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

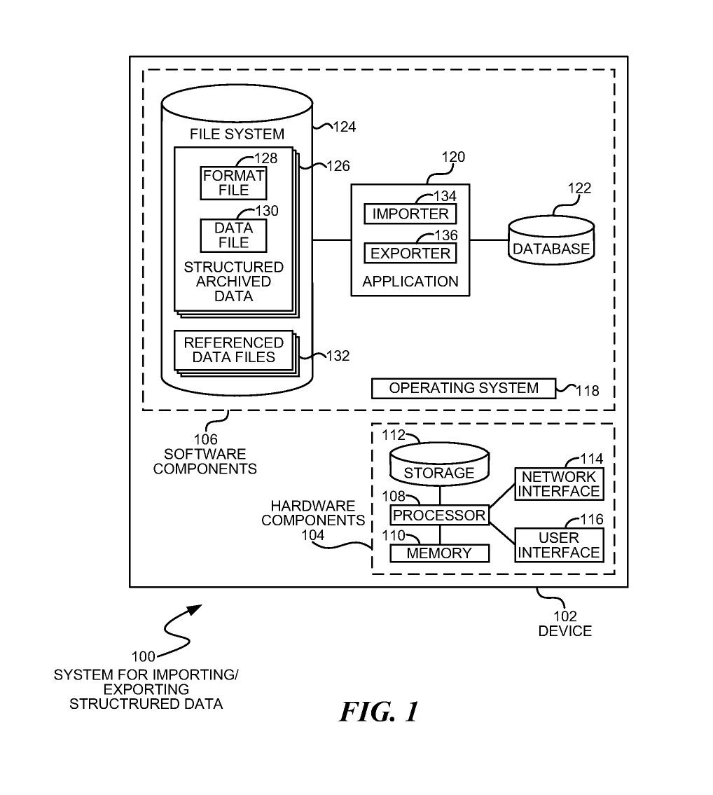

FIG. 1 is a diagram of an embodiment 100, showing a system that may export and import a data structure using a format file and a data file. Embodiment 100 is a simplified example of a device in which an application may export complex data for archiving or sharing with another application, as well as read in such data.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates a system that may import and export complex data structures using a flat or serialized data file. The complex data structures may include objects that have relationships between them, and may include several objects and several instances of objects. The data structure may be analyzed to define a set of properties for each object, then the properties may be stored in a flat data file, such as a comma separated values (CSV) file.

The structure data types may be stored in a format file that may be an XML or other description of a set of class types and the relationships between class types. The format file may be analyzed to determine a sequence of properties for the data file, and the same sequence may be used to store and retrieve instances of objects from the data file.

The data may be stored in two separate files, one with the data format and one with the data instance. The format file may be used to interpret the data file and may be stored with identical names but different file extensions in some embodiments.

The device 102 may be any type of computing device, and may be illustrated as a conventional computer device, such as a server computer or desktop computer. The device 102 may be any type of computing device, such as a network appliance, game console, laptop computer, netbook computer, tablet computer, personal digital assistant, mobile telephone, or any other device. The architecture illustrated in embodiment 100 may represent a generic computing architecture with a set of hardware components 104 and software components 106.

The hardware components 104 may include a processor 108, random access memory 110 and nonvolatile storage 112. The hardware components 104 may also include a network interface 114 and a user interface 116.

The software components 106 may include an operating system 118 on which various applications may operate, including the application 120.

The application 120 may have a database 122 or other data store, and may export and import data to a file system 124 using structured archived data 126. The structured archived data 126 may have two files: a format file 128 and a data file 130.

In some cases, the data file 130 may point to a referenced data file 132, which may contain one or more property values. The referenced data file 132 may be used in cases where a data file already exists or when a single data file may become very large, as well as other use scenarios.

The application 120 may include an importer 134 that may retrieve data from the structured archived data 126, as well as an exporter 136 that may create the structured archived data 126.

The importer 134 and exporter 136 may have several use scenarios. In one use scenario, data from one application may be exported to a format file and data file, then imported into a different application. For example, data may be exported from a computer management application and imported into a user's calendar application.

In another use scenario, data may be archived from a database and stored in a format file and data file. The archived data may be placed in a backup system or stored on archived media for disaster recovery, for example.

In still another use scenario, data may be transferred from one instance of an application to another. For example, a user may export data from an application running on one computer system and import the data into another instance of the same application that may be running on another computer system.

Examples of the operations that may be performed by the importer 134 and exporter 136 may be illustrated in embodiments 400 and 500, respectively.

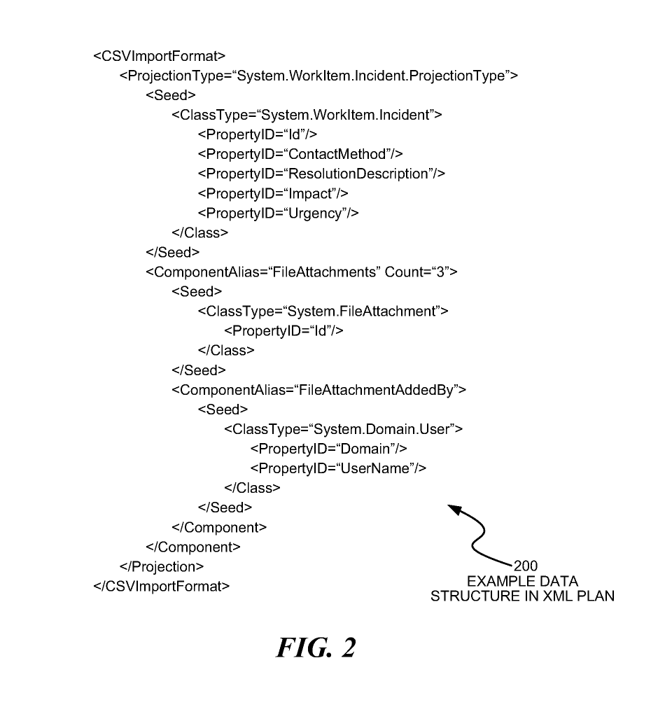

FIG. 2 is a diagram illustration of an example embodiment 200 showing a data structure definition. Embodiment 200 is an XML definition of a set of objects and their associated properties.

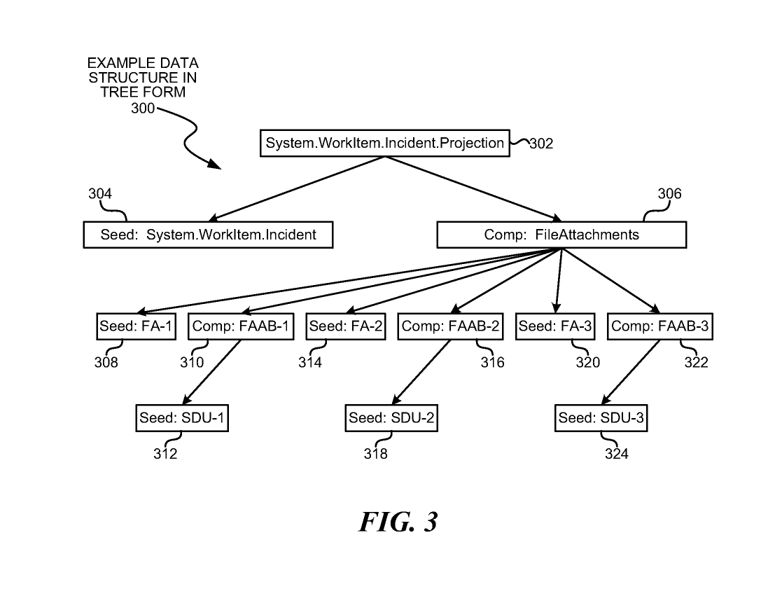

FIG. 3 is a diagram illustration of a tree illustration embodiment 300 of the data structure of embodiment 200. Embodiment 300 represents the tree representation of the XML defined in embodiment 200.

The example of embodiments 200 and 300 may be a set of objects from a help desk management system, where a call to a help desk may result in creating an incident, and each incident may have several file attachments. Each file attachment may have an identifier and may be added by a user. Each user may be defined by a domain and user name.

The data structure may include a data projection. A projection may define relationships between different objects. Examples of such relationships in embodiments 200 and 300 may be the union of System.Workitem.Incident 304 and the various file attachments 306, as well as the relationships between the various file attachments and the user associated with the file attachments.

The System.Workitem.Incident 304 may be defined in embodiment 200 to include several properties. Those properties may be “ID”, “ContactMethod”, “ResolutionDescription”, “Impact”, and “Urgency”.

The System.FileAttachement class may have a property of “ID”. Similarly, the System.Domain.User class may have properties of “Domain” and “UserName”.

In the XML of embodiment 200, the projection type may be an object that defines the ‘view’ or organization of the various objects from the database. The data structure of embodiment 200 may not be an exhaustive list of every property of the various objects, but may include a subset of the available properties.

The seed tags may define the class to which an object may belong. The ComponentAlias tags in the XML may identify groups of objects and the number of instances of the group. For example, the ComponentAlias “FileAttachments” has a Count=3. This statement indicates that three sets of “FileAttachments” are included.

For each of the FileAttachments, a FileAttachment ID is defined, along with a person who added the file. The person is defined using the FileAttachmentAddedBy component, which includes the System.Domain.User object.

The file attachment objects are illustrated as objects 308, 314, and 320, and the user objects are illustrated as objects 312, 318, and 324. The objects 310, 316, and 322 are instances of the component FileAttachmentAddedBy.

In order to create or read a corresponding data file for embodiment 200, the data structure may be traversed to identify all of the objects and instances of the objects within the data structure. In the case of embodiment 200, the objects may be System.Workitem.Incident, System.FileAttachment, and System.Domain.User.

Because the FileAttachments component is replicated three times, the objects may then be System.Workitem.Incident, (System.FileAttachment, System.Domain.User), (System.FileAttachment, System.Domain.User), and (System.FileAttachment, System.Domain.User).

Using the order of the objects above, the properties associated with the objects may be inserted in place of the objects, leaving the data file to contain these properties in this order: ID, ContactMethod, ResolutionDescription, Impact, Urgency, FileAttachment ID (1), Domain (1), UserName (1), FileAttachment ID (2), Domain (2), UserName (2), FileAttachment ID (3), Domain (3), UserName (3). The number in parentheses may indicate the instance of the property.

The instance data may be stored in a data file using the order of the properties as defined above.

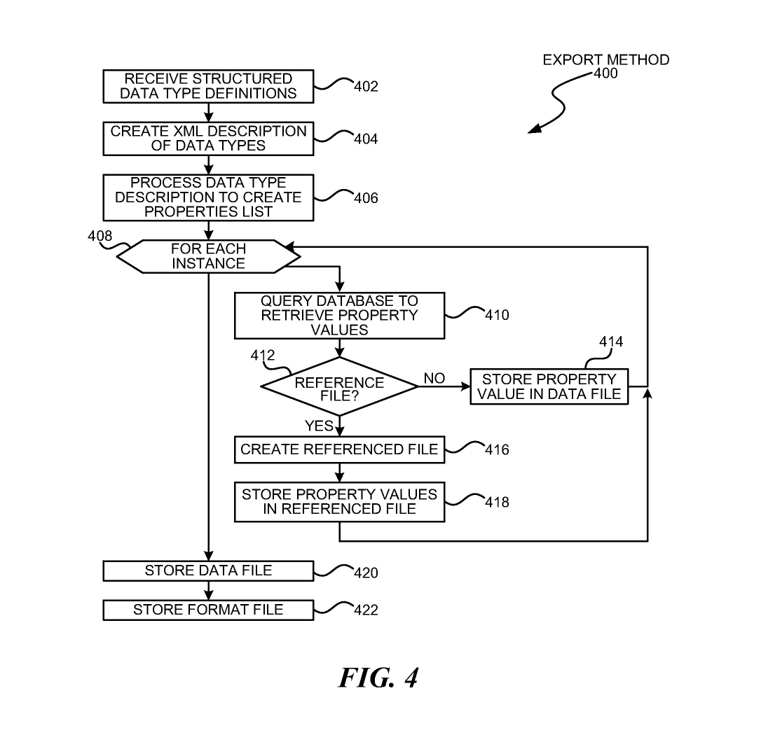

FIG. 4 is a flowchart illustration of an embodiment 400 showing a method for exporting data into a format file and a data file. Embodiment 400 is an example of a method that may be performed by an exporter 136 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates one method by which structured data may be exported into a format file and a data file. The data structure may be defined and then used to identify the properties that may be stored in the data file. Once the properties and the order of the properties are defined, the data file may be populated.

A set of structured data type definitions may be received in block 402. In some embodiments, the structured data type definitions may be an XML document that may be created by a person. In other embodiments, the structured data type definitions may be automatically generated from a data view, projection, or from a selection of objects by a user. An XML description of the data types may be defined in block 404.

The data type description may be processed in block 406 to create a list of properties. The list of properties may be determined in different manners in various embodiments. In the example of embodiments 200 and 300, each class may be organized in the order the class was presented in the format file. After organizing all of the classes in order, the properties of those classes may replace the classes to create a list of properties in a specific order.

The same algorithm may be used for both export and import of the data file.

For each instance of the structured data types in block 408, a query may be made to a database to retrieve property values 410. In some cases, the properties may be stored in a reference file. If the property is not in a reference file in block 412, the properties may be stored in the data file in block 414.

If the property is located in a reference file in block 412, a referenced file may be created in block 416 and the property may be stored in the reference file in block 418.

The reference file may be added to the data file by placing a pointer or Uniform Resource Identifier (URI) in the data file in place of a property value for a specific property.

After each instance is processed in block 408, the data file may be saved in block 420 and the format file may be saved in block 422.

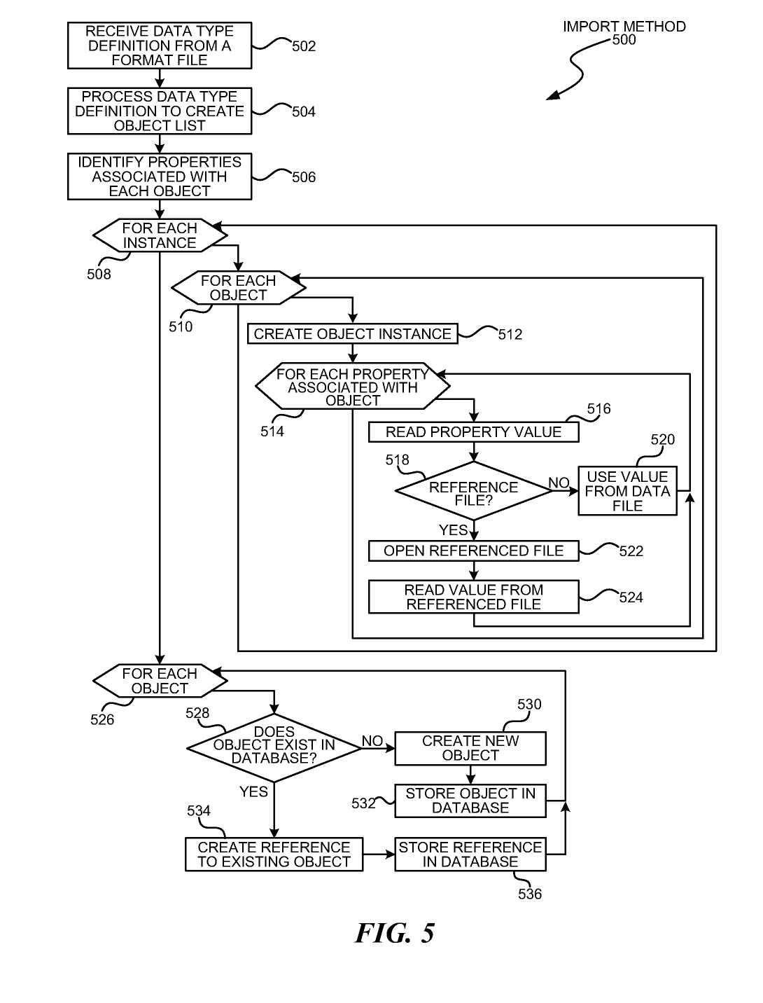

FIG. 5 is a flowchart illustration of an embodiment 500 showing a method for importing data from a format file and a data file into a database. Embodiment 500 is an example of a method that may be performed by an importer 134 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 illustrates a method by which objects may be imported into a database. A format file may be read and analyzed to identify the objects to be imported and the properties associated with the objects. The objects may be created and properties populated, then the objects may be added to a database.

A data type definition may be read from a format file in block 502.

The data type definition may be processed to create an object list in block 504, and the properties associated with each object may be identified in block 506. From blocks 502 through 506, a sequential list of properties may be identified, and the order of the properties may correspond with items in a data file.

A data file may contain rows of data, each row being an instance of the data type defined in the format time. For each instance in block 508, each object may be processed in block 510.

For each object in block 510, a new object instance may be created in block 512. For each property associated with the object in block 514, the property value may be read from a data file in block 516. If the value is not a reference to a reference file in block 518, the value may be used in block 520. If the value is a reference to a reference file in block 518, the reference file may be opened in block 522 and the property value may be read from the reference file in block 524.

Each property associated with the object may be processed in order in block 514, and each object in the data structure may be process in order in block 510.

After each instance is processed in block 508, the objects may be committed to a database beginning in block 526.

For each object in block 526, if the object does not exist in the database in block 528, a new object may be created in block 530 and the object may be stored in the database in block 532.

If the object does exist in the database in block 528, a reference may be created to the existing object in block 534 and the reference may be stored in the database in block 536.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving a data type definition in a format file, said data type definition comprising a hierarchical data type definition for a plurality of data types;
processing said data type definition to identify properties for each of said data types, and an order for each of said properties;
receiving a data file comprising instances of said data types, each of said instances comprising said properties according to said order;
for each of said instances, reading said properties from said data file to create said instance; and
storing said instance.

2. The method of claim 1, said plurality of data types comprising a parent/child relationship between a first data type and a second data type.

3. The method of claim 1, said plurality of data types being defined using a counter for a repeated instance of a first data type.

4. The method of claim 1, said format file being defined in XML.

5. The method of claim 4, said data file being defined in a separated values file comprising a delimiter between each of said properties.

6. The method of claim 5, said delimiter being a comma.

7. The method of claim 1, said data type definition comprising property definition for a first property.

8. The method of claim 7 further comprising:
receiving a property value from said data file for said first property; and
checking said property value against said property definition.

9. The method of claim 1, said instance being stored in a database.

10. The method of claim 9, said database having a predefined set of data types corresponding to said plurality of data types.

11. The method of claim 1 further comprising:
reading a first property and detecting a first property comprising a reference to a first external file; and
reading said first external file to determine said first property.

12. A computer readable storage medium comprising computer executable instructions that perform the method of claim 1.

13. A method performed on a computer processor, said method comprising:
receiving a data structure definition comprising a first data type and a second data type;
creating a format file comprising said data structure definition;
using said data structure definition to identify a plurality of properties and an order for said properties;
receiving a plurality of instances for said data structure definition;
for each of said plurality of instances, identifying a property value for each said plurality of properties, organizing said property values according to said order, and adding said property values in a data file; and
saving said data file.

14. The method of claim 13, said first data type and said second data type having a relationship defined in said format file.

15. The method of claim 14, said relationship being a parent/child relationship.

16. The method of claim 15, said plurality of instances being received from a database.

17. The method of claim 16, said database being used to derive at least a portion of said data structure definition.

18. A system comprising:
a processor;
a file system;
a database comprising instances of data types;
a data import system that:
receives a data type definition in a first format file, said data type definition comprising a hierarchical data type definition for a plurality of data types;
processes said data type definition to identify properties for each of said data types, and an order for each of said properties;
receives a second data file comprising instances of said data types, each of said instances comprising said properties according to said order;
for each of said instances, reads said properties from said data file to create said instance; and
stores said instance in said database.

19. The system of claim 18 further comprising:
a data export system that:
receives a data structure definition comprising a first data type and a second data type, said data structure definition being at least partially defined in said database;
creates a second format file comprising said data structure definition;
uses said data structure definition to identify a plurality of properties from said database and an order for said properties;
receives a plurality of instances for said data structure definition;
for each of said plurality of instances, identifies a property value for each said plurality of properties, organizes said property values according to said order, and adds said property values in a second data file; and
saves said second data file.

20. The system of claim 19, said first format file being defined in XML and said first data file being a comma separated value file.
